(19) United States
(12) Patent Application Publication
(10) Pub. No.: US 2023/0376946 A1
(43) Pub. Date: Nov. 23, 2023

(54) SYSTEMS AND METHODS FOR USE IN ENABLING MESSAGING

(71) Applicant: VOCALINK LIMITED, LONDON (GB)

(72) Inventors: An Ni Tan, London (GB); Pramodh Chelimala, Sutton (GB); Vasileios Karavas, London (GB)

(21) Appl. No.: 17/827,987

(22) Filed: May 30, 2022

(30) Foreign Application Priority Data
May 20, 2022 (GR) 20220100422

(51) Int. Cl. G06Q 20/38; G06Q 20/42; G06Q 20/10

(52) U.S. Cl. CPC G06Q 20/386; G06Q 20/42; G06Q 20/102

(57) ABSTRACT

Systems and methods are provided for enabling messaging associated with partial bill payment operations. One example computer-implemented method includes receiving a first message from a first party associated with a first partial payment to a bill and issuing a first technical acknowledgment of the first message. The method also includes appending a first account service reference (ASR) to the first message, where the first ASR is specific to the first partial payment and the bill, and issuing the first message with the first ASR to a second party associated with the bill. The method then includes, later, receiving a second message from the first party associated with a second partial payment to the bill, where the second message includes a second ASR, issuing a second technical acknowledgment of the second message, and issuing the second message, with the second ASR, to the second party.

### CROSS-REFERENCE TO RELATED APPLICATION

This application claims the benefit of, and priority to, Greek Patent Application No. 20220100422, filed May 20, 2022. The entire disclosure of the above application is incorporated herein by reference.

### FIELD

The present disclosure is generally directed to systems and methods for use in enabling messaging, and in particular, to enabling messaging associated with partial operations (e.g., partial bill payment, etc.).

### BACKGROUND

This section provides background information related to the present disclosure which is not necessarily prior art.

Users often purchase goods and services through various processes, whereby, once purchased, funds may be due for the goods and services once at the time of purchase, or periodically thereafter. It should be appreciated that when bills are presented for the goods or services, the users, in general, pay the bills (e.g., through cash, checks, payment accounts, etc.) and proceed to receive or retain the goods or services. When the bills go unpaid, providers of the goods or services may cease providing the goods and services to the users or request return thereof.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in extending data files for users, and enabling messaging between an institution and a service provider;

FIG. 2 is a block diagram of an example computing device that may be used in the system of FIG. 1; and

FIG. 3 illustrates an example method, which may be implemented in connection with the system of FIG. 1, for enabling confirmation messaging associated with a billing sequence, which includes more than one payment for a given bill.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When a user is presented with a bill for a product/service, the user may pay the bill, and the product/service is then delivered or otherwise provided (e.g., to the user, etc.). In a situation, for example, where the user may make a partial payment of the bill, and then later makes another partial payment of the bill, the payments are identified to the bill, but are not independently identified. As such, messaging associated with the bill being paid is unspecific to a subsequent payment, whereby recordation of the payments, together, is difficult.

Uniquely, the systems and methods herein provide for enabling messaging for a partial payment, whereby different payments for the same bill are associated with a distinct identifier to distinguish the payments. In this manner, a payer is able to make multiple payments against a bill, where a unique identifier is provided by a messaging platform for each payment confirmation. The unique identifier is provided to both a service provider and an institution involved in the payment(s) as a common reference for the particular payment. Also, in instances in which a payment is initially scheduled, the institution is able to use the same identifier to indicate that the scheduled payment has now being paid. When a service provider and/or an institution then sends an acknowledgement of acceptance or rejection of the payment, the unique reference is used, again, to identify the particular payment being accepted or rejected. As such, the identifier further ties a scheduled payment to a payment being made (and potentially the bill), through the payment acknowledgement provided by the service provider.

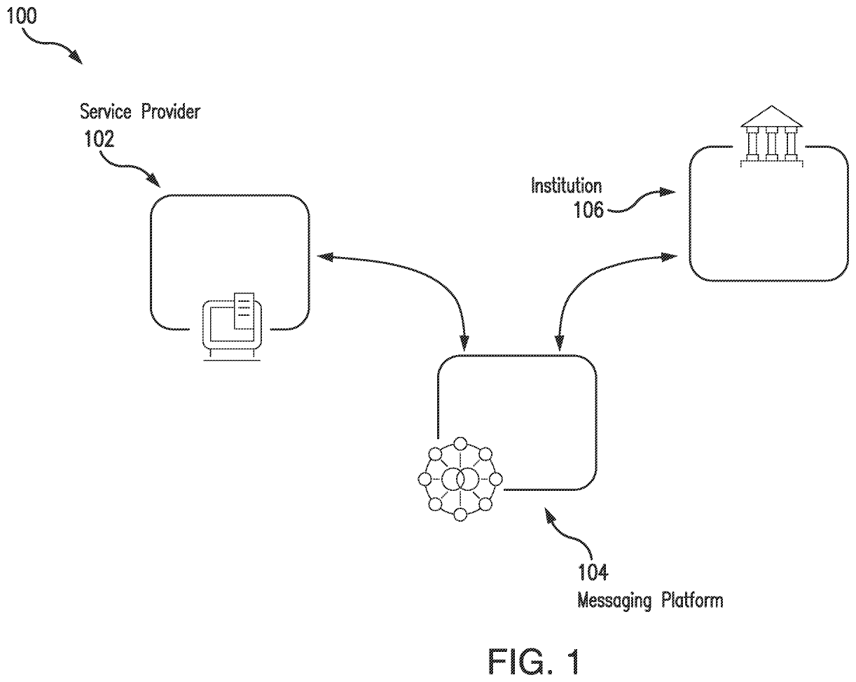

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, arrangements between billing services and providers, privacy rules and requirements, etc.

The system 100 generally includes a service provider 102, a messaging platform 104, and a payer institution 106, each of which is coupled to one or more networks to provide communication therebetween. The network(s) is/are indicated generally by arrowed lines in FIG. 1, and each may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The service provider 102 of the system 100 generally is associated with bill pay services, whereby in the illustrated embodiment the service provider 102 includes a biller service provider. In connection therewith, the service provider 102 may be configured to issue bills (also referred to as invoices) on behalf of one or more clients (e.g., merchants, service providers, etc.) to payers, and then to participate in the payment of funds to satisfy the bills and remittance of funds, from the payers to the one or more clients.

The payer institution 106 of the system 100 is configured to make payments of funds from an account associated with a payer (or debtor) to the service provider 102, to satisfy a bill issued to the payer by the service provider 102. In some embodiments, the payer institution 106 may be referred to as a debtor service provider. In general, payments remitted to the service provider 102 are at the direction of the payer to the payer institution 106 (e.g., via a web-based application, web interface, etc.). As such, the payer, for each payment, is permitted to set a source account, a date and/or time, and an amount of the payment, along with a reference to the bill (e.g., by reference identifier, etc.).

In this exemplary embodiment, the messaging platform 104 is intermediate to the service provider 102 and the payer institution 106. The messaging platform 104, in turn, is coupled in communication with each of the service provider 102 and the payer institution 106. The messaging platform 104 is configured to coordinate messaging, as described in more detail below, between the service provider 102 and the payer institution 106. While illustrated as a separate, standalone service in FIG. 1, it should be appreciated that the messaging platform 104 may be integrated, in whole or in part, into a network associated with other services, such as, for example, a payment processing system/network (e.g., MASTERCARD, VISA, AMERICAN EXPRESS, or VOCALINK, payment systems, etc.).

It should be appreciated that more than one service provider and/or payer institution (along with various payers) may be coupled in communication with the messaging platform 104.

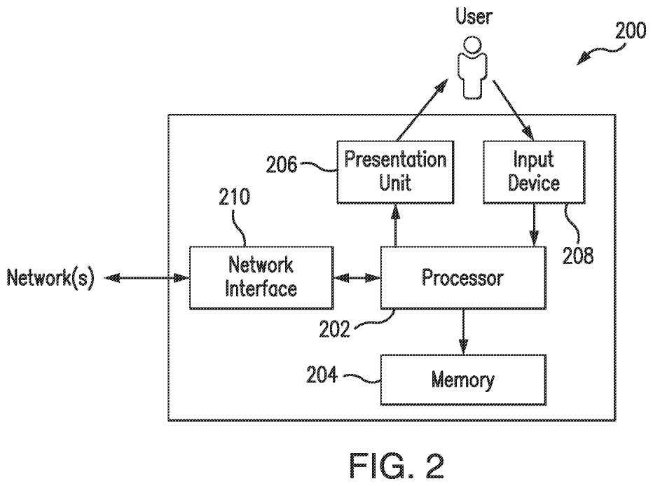

FIG. 2 illustrates an example computing device 200 that may be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the service provider 102, the messaging platform 104, and the payer institution 106 should be understood to include, or as being implemented or embodied in, a computing device at least partially consistent with the computing device 200, coupled to (and in communication with) one or more of the networks. However, the system 100 should not be considered limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identifiers, reference numbers, payment data, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein (e.g., one or more of the operations of method 300, etc.), whereby upon (or in connection with) performing such operation(s) the computing device 200 may be transformed into a special purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200, whereby the information may be displayed at (or otherwise emitted from) computing device 200, and in particular at presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, account designations, payment amounts, etc., as further described herein. The input device 208 may include a single input device or multiple input devices. The input device 208 is coupled to (and is in communication with) the processor 202 and may include, for example, one or more of a keyboard, a pointing device, a mouse, a camera, a biometric reader, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different ones of the networks herein and/or with other devices described herein. In some example embodiments, the computing device 200 may include the processor 202 and one or more network interfaces incorporated into or with the processor 202.

Referring again to FIG. 1, the service provider 102 is configured to issue a bill to a payer, where the bill reflects an amount due (e.g., to a merchant, service provider, etc.). In response, the payer may decide, or desire, to make a payment, which is for less than the entire amount due. For example, the payer may have only a portion of the funds available in an account issued by the payer institution 106. As such, the payer directs the payer institution 106 to direct a payment, in an amount less than the total due, to the service provider 102 for the bill. In addition, the service provider 102 transmits the bill (and/or a payment request associated therewith) to the platform 104. And, the platform 104 generates a reference number for (or specific to) the bill/payment request.

In connection therewith, the payer institution 106 is configured to initiate the transaction, and further to send a payment confirmation advice message (which includes payment settlement details, such as, for example, amount, date, etc.) to the platform 104. The platform 104 is configured to match (or link) the payment confirmation advice message to the bill/payment request received from the service provider 102 (so that the platform 104 and the service provider 102 know to which bill the payment confirmation advice message (and payment settlement details included therein) is directed). The platform 104 is also configured to validate the payment confirmation advice message from the payer institution 106. The validation may include, for example, a structural validation to ensure that the message is in the proper or expected form and/or format. The validation may also include a security validation, whereby the message is validated based on encryption, signatures, keys and/or certificates associated with the message, as applicable. And/or, the validation may further include a business validation, where the payer institution 106 is validated, along with the service provider 102 to which the payment is directed, and potentially, also the payer, the type of request, the amount, etc.

In response to validation of the payment confirmation advice message, the platform 104 is configured to issue a technical acknowledgement to the institution 106, which indicates, in part, that the payment confirmation advice message has been received and/or validated by the platform 104. The technical acknowledgement may also include the reference number for the bill/payment request, for example, for use by the payer institution 106 in subsequent messages relating to the bill/payment request. In turn, the platform 104 is configured to generate and append a unique identifier to the technical acknowledgement specific to the payment to be made for the bill. The unique identifier may be referred to as an account service reference (ASR) (or first ASR or ASR1 in this payment example). In this way, the bill/payment request (via the reference number associated therewith) and the ASR1 are linked together.

In addition, in response to the validation of the payment confirmation advice message, the platform 104 is also configured to pass the payment confirmation advice message to the service provider 102. In connection therewith, the platform 104 is configured to append the ASR1 to the payment confirmation advice message. In turn, the service provider 102 is configured to issue a technical acknowledgement of the payment confirmation advice message (e.g., to the messaging platform 104, etc.), which is indicative of, for example, mere receipt of the message by the service provider 102. Conversely, if the platform 104 is unable to reach the service provider 102, or no technical acknowledge is issued by the service provider 102, the platform 104 is configured, for example, to retry sending the payment confirmation advice message to the service provider 102 a set number of times, and if still unsuccessful, configured to determine a timeout after a defined interval. In the case of the timeout, the platform 104 is configured to issue an error notification to the payer institution 106 for the advice message. In some embodiments, then, the payer institution 106, in turn, may be configured to issue a technical acknowledgement of the error notification (e.g., to the messaging platform 104, etc.) (although this is not required).

After the payment is completed to the service provider 102, the service provider 102 is configured to issue a payment acknowledgement message of the partial payment to the platform 104. The acknowledgement message includes a biller reference number (BRN) and the ASR1 received from the platform 104, as explained above. The platform 104 is configured to perform a validation check on the payment acknowledgement message, and then, to issue a technical acknowledgement of the payment acknowledgement message (e.g., to the service provider 102, etc.). In addition, the platform 104 is configured to issue a payment acknowledgement to the payer institution 106, which also includes the ASR1 (to thereby allow the payer institution 106 to identify the particular payment to which the payment acknowledgement message is directed and related BRN). In response, the payer institution 106 is configured to issue a technical acknowledgement back to the platform 104.

At about the same time, or subsequently, the payer may schedule (or make) another partial payment at a later date to the bill issued by the service provider 102, whereby the payer institution 106 is instructed as explained above. In connection therewith, the payer institution 106 is configured to send a payment confirmation advice message to the platform 104, for example, to indicate that the subsequent payment is scheduled (including the reference number for (or specific to) the bill/payment request as previously generated by the platform 104). In this example, then, the payment confirmation advice message also includes an indication of the scheduled status of the payment for a later date. Upon receipt, the platform 104 is configured to validate the payment confirmation advice message from the payer institution 106.

And, in response to validation of the payment confirmation advice message, the platform 104 is configured to issue a technical acknowledgement to the payer institution 106, which indicates, in part, that the payment confirmation advice message has been received and/or validated by the platform 104. The platform 104 is also configured to generate a second unique identifier specific to the subsequent scheduled payment to be made for the bill, and append the second unique identifier to the technical acknowledgement to the payer institution 106. The second unique identifier may be referred to herein as a second ASR, or ASR2. In this way, the original bill/payment request (via the reference number associated therewith) and the ASR2 are linked together. And, the payer institution 106 is able to link the technical acknowledgement to the given bill/payment request (via the ASR2). Further, the payer institution 106 is configured to later include the ASR2 in a subsequent payment confirmation advice message to the platform 104, on the actual date the scheduled payment is to take place, so that the platform 104 and the service provider 102 can tell that the previously scheduled payment has been made.

In addition, the platform 104 is also configured to forward the payment confirmation advice message (including the reference number associated with the original bill/payment request and the ASR2, indicative of the scheduled payment) to the service provider 102. In this manner, the service provider 102 is informed of the scheduled partial payment for the particular bill/payment request and the ASR2 (indicative of the scheduled payment therefore). In turn, the service provider 102 is configured to issue a technical acknowledgement of the payment confirmation advice message, which is indicative of, for example, mere receipt of the payment confirmation advice message by the service provider 102.

Conversely, if the platform 104 is unable to reach the service provider 102, or no technical acknowledge is issued by the service provider 102, the platform 104 is configured to retry sending the payment confirmation advice message to the service provider 102 a predefined (or set) number of times and, if still unsuccessful, to determine a timeout after a defined interval and to issue an error notification to the payer institution 106 for the payment confirmation advice message. The payer institution 106, in turn, is configured to issue a technical acknowledgement of the error notification to the platform 104 (as generally described above).

Next, the payer institution 106 is configured to notify the platform 104 that the scheduled payment has taken place, or proceeded, and/or has been processed. In particular, for instance, after the scheduled payment has been processed, the payer institution 106 may be configured to issue a subsequent payment confirmation advice message, using the ASR2, indicating that the scheduled payment has now be paid and/or completed. Upon receipt, the platform 104 is configured to validate the subsequent payment confirmation advice message from the payer institution 106 (as generally described above). And, in response to validation of the subsequent payment confirmation advice message, the platform 104 is configured to forward the payment confirmation message to the service provider 102 (indicating completion of the payment, etc.).

After the scheduled payment is actually completed to the service provider 102, the service provider 102 is configured to issue a payment acknowledgement message of the further partial payment to the platform 104. The acknowledgement message includes a biller reference number (BRN) and the ASR2 received from the platform 104, as explained above. The platform 104 is configured to perform a validation check on the payment acknowledgement message, and then, to issue a technical acknowledgement of the payment acknowledgement message. In addition, the platform 104 is configured to issue a payment acknowledgement to the payer institution 106, again including the ASR2 (to thereby align the acknowledgement with the scheduled payment). In response, the payer institution 106 is configured to issue a technical acknowledgement back to the platform 104.

It should be appreciated that further (subsequent) payments may be scheduled and made in a similar manner. In doing so, additional unique identifiers (e.g., additional ASRs, etc.) may be generated by the platform 104 for each payment and linked to the reference number for the underlying bill/payment request. In this way, the different payments (as identified by the different unique identifies) may be linked to the same appropriate bill/payment request.

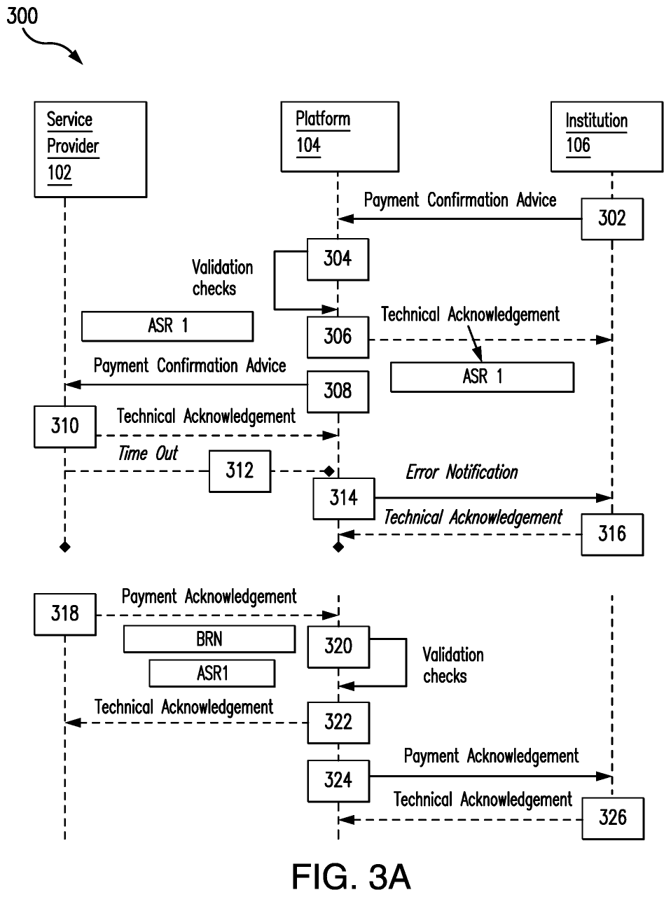

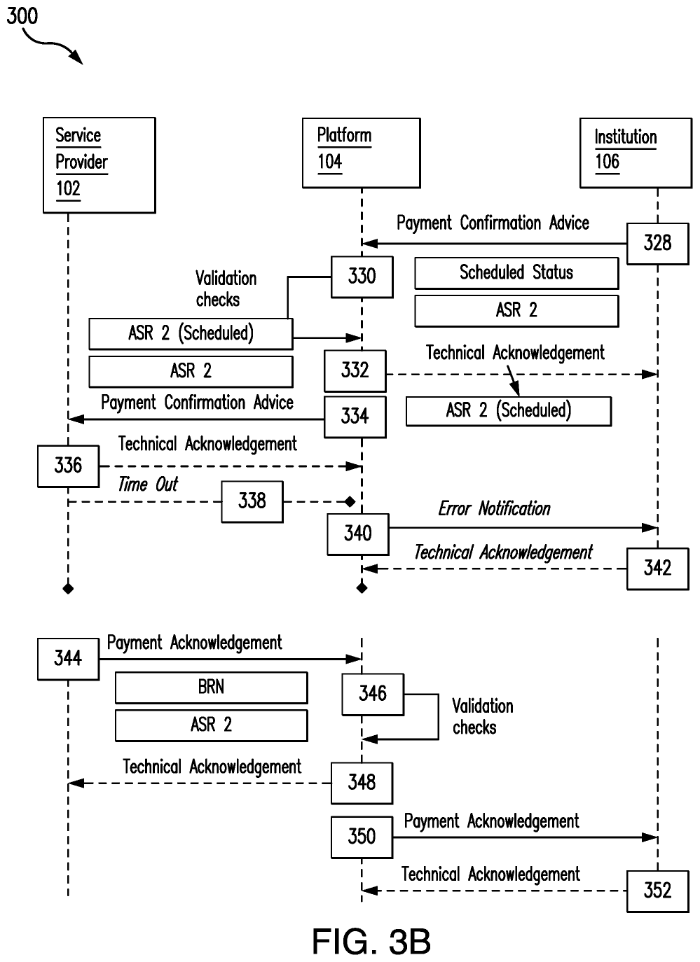

FIG. 3 illustrates an example method 300 for use in enabling messaging, between an institution and a service provider. The example method 300 is described as implemented in the service provider 102, the platform 104 and the institution 106 of the system 100. Reference may also be made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset in the method 300, it should be appreciated that a payer is in debt to a merchant, for example, in connection with delivery/procurement of a product or a service offered for sale by the merchant. In connection with the purchase, a bill is generated in association with the service provider 102 and provided to the payer. In addition in this example, the service provider 102 transmits the bill to the platform 104, and the platform 104 generates a reference number for (or specific to) the bill.

In response to the obligation, the payer decides to make a partial payment via the payer institution 106, whereby the payer directs the payer institution 106 as to the amount of the payment. In this example, the payer decides to pay $50 of a $200 bill being serviced by the service provider 102. In connection therewith, the payer institution 106 initiates the payment of $50 from an account issued to the payer.

Following the payment (by the payer institution 106), the payer institution 106 issues, at 302, a payment confirmation advice message (including settlement details for the payment, such as, amount, etc.) to the platform 104. The platform 104 matches (or links) the received payment confirmation advice message to the corresponding bill received from the service provider 102, for example, based on the reference number for the bill. The platform 104 validates, at 304, the payment confirmation advice message from the payer institution 106. The validation may include, for example, as explained above: a structural validation to ensure that the message is in the proper or expected form and/or format; a security validation, whereby the message is validated based on encryption, signatures, keys and/or certificates associated with the message, as applicable; and/or a business validation, where the institution 106, the payer, and the service provider 102 are validated as proper, etc.

In response to validation of the message, the platform 104 issues, at 306, a technical acknowledgement (e.g., a message, etc.) to the institution 106, which indicates, in part, that the confirmation advice message has been received and/or validated by the platform 104. The technical acknowledgement may also include the reference number for the bill/payment request, for example, for use by the payer institution 106 in subsequent messages relating to the bill/payment request. The technical acknowledgement includes an ASR1 (broadly, a unique identifier) for the first payment associated with the bill. In addition, in response to the validation of the message, the platform 104 appends the ASR1 to the payment confirmation advice message and passes, at 308, the payment confirmation advice message, with the ASR1 appended thereto, to the service provider 102. The bill (via the reference number associated therewith) and the ASR1 are thus also linked together.

In turn, the service provider 102 issues a technical acknowledgement (e.g., a message, etc.) to the platform 104, at 310, in response to the payment confirmation advice message, which is indicative of, for example, receipt of the payment confirmation advice message by the service provider 102. Conversely in the method 300, if the platform 104 is unable to reach the service provider 102 or the technical acknowledge is not issued by the service provider 102 within a defined interval (e.g., seconds, minutes, etc.), the platform 104 may retry sending the payment confirmation advice message to the service provider 102 a predefined (or set) number of times and, if still unsuccessful, determines, at 312, the message has timed out, and issues, at 314, an error notification (e.g., a message, etc.) to the payer institution 106 for the payment confirmation advice message. The payer institution 106, in turn, issues, at 316 (optionally), a technical acknowledgement (e.g., a message, etc.) of the error notification to the platform 104.

After the payment is completed to the service provider 102 (following the technical acknowledgement at 308) (e.g., accepted by the service provider 102, accepted by the merchant, etc.), the service provider 102 issues, at 318, a payment acknowledgement message of the partial payment to the platform 104 (e.g., indicating acceptance of the payment, etc.). The payment acknowledgement message includes, as shown, a BRN and also the ASR1 received from the platform 104. At, 320, the platform 104 performs a validation check on the message (e.g., structural validation, security validation, business validation, etc.) and then issues, at 322, a technical acknowledgement (e.g., a message, etc.) of the payment acknowledgement to the service provider 102.

In addition, the platform 104 issues, at 324, a payment acknowledgement (e.g., a message, etc.) to the payer institution 106. The payment acknowledgement also includes the ASR1 (to thereby allow the payer institution 106 to identify the particular payment to which the payment acknowledgement message is directed and related BRN). In response, at 326, the payer institution 106 issues a technical acknowledgement (e.g., a message, etc.) back to the platform 104.

In connection therewith, or subsequently, the payer may schedule another partial payment for a later date to the bill issued by the service provider 102, whereby the payer institution 106 is instructed as explained above. In doing so, the payer institution 106 issues, at 328, a payment confirmation advice message to the platform 104 for the further partial payment, for example, to indicate that the subsequent payment is scheduled (including the reference number for (or specific to) the bill/payment request as previously generated by the platform 104). The payment confirmation advice message thus includes an indication of the scheduled status of the payment for the later date. Upon receipt, at 330, the platform 104 validates the payment confirmation advice message from the payer institution 106 (e.g., structural validation, security validation, business validation, etc., as described above; etc.).

After validation, the platform 104 issues, at 332, a technical acknowledgement (e.g., a message, etc.) to the payer institution 106, which indicates, in part, that the confirmation advice message has been received and/or validated by the platform 104. The platform 104 also generates an ASR2 for the scheduled payment and includes the ASR2 in the technical acknowledgement. What's more, the platform 104 forwards, at 334, the payment confirmation advice message (including the ASR2 and indication of the payment being scheduled) to the service provider 102.

In turn, the service provider 102 issues, at 336, a technical acknowledgement (e.g., a message, etc.) of the payment confirmation advice message, which is indicative of, for example, receipt of the message by the service provider 102.

If the platform 104 is unable to reach the service provider 102 or no technical acknowledgement is issued by the service provider 102 within a defined interval, the platform 104 may retry sending the payment confirmation advice message to the service provider 102 a predefined (or set) number of times and, if still unsuccessful, determines, at 338, a timeout after a defined interval and issues, at 340, an error notification (e.g., a message, etc.) to the payer institution 106 for the payment confirmation advice message. The payer institution 106, in turn, issues, at 342 (optionally), a technical acknowledgement (e.g., a message, etc.) of the error notification back to the platform 104.

Subsequently, the payer institution 106 notifies the platform 104 that the scheduled payment has actually taken place, or proceeded, and/or has been processed. And, after the scheduled payment has been processed, the payer institution 106 issues a subsequent payment confirmation advice message (e.g., at 328, etc.), using the ASR2, indicating that the scheduled payment has now been paid and/or completed. Upon receipt, the platform 104 validates the subsequent payment confirmation advice message from the payer institution 106 (as generally described above at 330) and proceeds with a technical acknowledgement to the payer institution (as described above at 332). Additionally, in response to validation of the subsequent payment confirmation advice message, the platform 104 forwards the payment confirmation message to the service provider 102 (indicating completion of the payment, etc.) (at 334), and the steps described above at 336-342 are generally repeated (for the actual payment).

In turn, the service provider 102 issues, at 344, a payment acknowledgement message of the actual completion of the partial payment to the platform 104. The payment acknowledgement message includes a BRN and the ASR2 received from the platform 104, as explained above. The platform 104 performs, at 346, a validation check on the message (e.g., structural validation, security validation, business validation, etc.), and then issues, at 348, a technical acknowledgement (e.g., a message, etc.) of the payment acknowledgement to the service provider 102. In addition, the platform 104 issues, at 350, a payment acknowledgement (e.g., a message, etc.) to the payer institution 106. And, in response, the payer institution issues, at 352, a technical acknowledgement (e.g., a message, etc.) back to the platform 104.

In view of the above, the systems and methods herein provide for enabling messaging, between a payer institution and a service provider. In connection therewith, the systems and method herein may provide a mechanism to tie scheduled payments to payments that have been made by the payer institution, through the acceptance/rejection of individual payments from the service provider. This is distinct from conventional messaging, in which only single payments are permitted. The description herein therefore provides for increased flexibility for both payer institutions and service providers supporting multiple payments while maintaining message reconciliation processes, through the unique identifiers, thereby providing enhanced functionality.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) receiving a first confirmation advice message from a first party associated with a first partial payment to a bill; (b) issuing a first technical acknowledgment of the first confirmation advice message; (c) appending a first account service reference (ASR) to the first confirmation advice message, the first ASR specific to the first partial payment and the bill; (d) issuing the first confirmation advice message with the first ASR to a second party associated with the bill; and later, (e) receiving a second confirmation advice message from the first party associated with a second partial payment to the bill, the second confirmation advice message including a second ASR, which is different than the first ASR, yet specific to the bill; (f) issuing a second technical acknowledgment of the second confirmation advice message; and (g) issuing the second confirmation advice message, with the second ASR, to the second party associated with the bill.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” as well as the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in enabling messaging associated with partial bill-payment operations, the method comprising:
receiving, by a computing device, a first confirmation advice message from a first party associated with a first partial payment to a bill;
issuing, by the computing device, a first technical acknowledgment of the first confirmation advice message;
appending a first account service reference (ASR) to the first confirmation advice message, the first ASR specific to the first partial payment and the bill;
issuing, by the computing device, the first confirmation advice message with the first ASR to a second party associated with the bill; and later,
receiving, by the computing device, a second confirmation advice message from the first party associated with a second partial payment to the bill, the second confirmation advice message including a second ASR specific to the second partial payment, the second ASR different than the first ASR, yet specific to the bill;
issuing, by the computing device, a second technical acknowledgment of the second confirmation advice message; and
issuing, by the computing device, the second confirmation advice message, with the second ASR, to the second party associated with the bill.

2. The computer-implemented method of claim 1, wherein the first party includes a first banking institution, and the second party includes a biller service provider.

3. The computer-implemented method of claim 1, wherein the second partial payment includes a scheduled partial payment; and
wherein the method further comprises generating the second ASR for the second partial payment prior to receiving the second confirmation advice message from the first party.

4. The computer-implemented method of claim 1, further comprising validating, by the computing device, the first and/or second confirmation advice message, prior to issuing the corresponding first and/or second technical acknowledgement to the first party.

5. The computer-implemented method of claim 1, further comprising:
receiving, by the computing device, a payment acknowledgement message from the second party associated with the second partial payment to the bill, the payment acknowledgement message including the second ASR and a biller reference number (BRN); and
issuing, by the computing device, the payment acknowledgement message including the second ASR to the first party.

6. The computer-implemented method of claim 5, further comprising validating, by the computing device, the payment acknowledgement message, prior to issuing the payment acknowledgement message to the first party.

7. The computer-implemented method of claim 1, wherein the computing device is included in a payment network associated with the first and second partial payments.

8. A non-transitory computer-readable storage medium comprising executable instructions for use in enabling messaging associated with partial bill-payment operations, which when executed by at least one processor of a computing device, cause the at least one processor to:
receive a first confirmation advice message from a first party associated with a first partial payment to a bill;
issue a first technical acknowledgment of the first confirmation advice message;
append a first account service reference (ASR) to the first confirmation advice message, the first ASR specific to the first partial payment and the bill;
issue the first confirmation advice message with the first ASR to a second party associated with the bill; and later,
receive a second confirmation advice message from the first party associated with a second partial payment to the bill, the second confirmation advice message including a second ASR specific to the second partial payment, the second ASR different than the first ASR, yet specific to the bill;
issue a second technical acknowledgment of the second confirmation advice message; and
issue the second confirmation advice message, with the second ASR, to the second party associated with the bill.

9. The non-transitory computer-readable storage medium of claim 8, wherein the first party includes a first banking institution, and the second party includes a biller service provider.

10. The non-transitory computer-readable storage medium of claim 8, wherein the second partial payment includes a scheduled partial payment; and
wherein the executable instructions, when executed by the at least one processor of the computing device, further cause the at least one processor to generate the second ASR for the second partial payment prior to receiving the second confirmation advice message from the first party.

11. The non-transitory computer-readable storage medium of claim 8, wherein the executable instructions, when executed by the at least one processor of the computing device, further cause the at least one processor to validate the first and/or second confirmation advice message, prior to issuing the corresponding first and/or second technical acknowledgement to the first party.

12. The non-transitory computer-readable storage medium of claim 8, wherein the executable instructions, when executed by the at least one processor of the computing device, further cause the at least one processor to:
receive a payment acknowledgement message from the second party associated with the second partial payment to the bill, the payment acknowledgement message including the second ASR and a biller reference number (BRN); and
issue the payment acknowledgement message including the second ASR to the first party.

13. The non-transitory computer-readable storage medium of claim 12, wherein the executable instructions, when executed by the at least one processor of the computing device, further cause the at least one processor to validate the payment acknowledgement message, prior to issuing the payment acknowledgement message to the first party.

14. The non-transitory computer-readable storage medium of claim 8, wherein the computing device is included in a payment network associated with the first and second partial payments.

15. A system for use in enabling messaging associated with partial bill-payment operations, the system comprising:
a payment network including at least one computing device configured to:
receive a first confirmation advice message from a first party associated with a first partial payment to a bill;
issue a first technical acknowledgment of the first confirmation advice message;
append a first account service reference (ASR) to the first confirmation advice message, the first ASR specific to the first partial payment and the bill;
issue the first confirmation advice message with the first ASR to a second party associated with the bill; and later,
receive a second confirmation advice message from the first party associated with a second partial payment to the bill, the second confirmation advice message including a second ASR specific to the second partial payment, the second ASR different than the first ASR, yet specific to the bill;
issue a second technical acknowledgment of the second confirmation advice message; and
issue the second confirmation advice message, with the second ASR, to the second party associated with the bill.

16. The system of claim 15, wherein the first party includes a first banking institution, and the second party includes a biller service provider.

17. The system of claim 15, wherein the second partial payment includes a scheduled partial payment; and
wherein the at least one computing device is further configured to generate the second ASR for the second partial payment prior to receiving the second confirmation advice message from the first party.

18. The system of claim 15, wherein the at least one computing device is further configured to validate the first and/or second confirmation advice message, prior to issuing the corresponding first and/or second technical acknowledgement to the first party.

19. The system of claim 15, wherein the at least one computing device is further configured to:
receive a payment acknowledgement message from the second party associated with the second partial payment to the bill, the payment acknowledgement message including the second ASR; and
issue the payment acknowledgement message including the second ASR to the first party.

20. The system of claim 19, wherein the at least one computing device is further configured to validate the payment acknowledgement message, prior to issuing the payment acknowledgement message to the first party.
